(19) United States
(12) Patent Application Publication
(10) Pub. No.: US 2008/0008518 A1
(43) Pub. Date: Jan. 10, 2008

(54) Accessory for a writing utensil

(75) Inventors: Richard Poaps, Oakville (CA); Philip White, North York (CA)

Correspondence Address: ROGERS TOWERS, P.A., 1301 RIVERPLACE BOULEVARD, SUITE 1500, JACKSONVILLE, FL, 32207, US

(73) Assignee: Richard Poaps

(21) Appl. No.: 11/482,872

(22) Filed: Jul. 10, 2006

(51) Int. Cl. B43K 29/00

(52) U.S. Cl. 401/195

(57) ABSTRACT

An accessory for a writing utensil includes a paper roll; a housing having an outer cavity to receive the paper roll, and an inner cavity to releasably receive an end of the writing utensil. The housing has a slot in a perimeter wall thereof to feed paper from the paper roll in the outer cavity to the exterior of the housing.

### FIELD OF THE INVENTION

The methods and systems disclosed herein relate generally to writing utensils, and more particularly to an accessory for a writing utensil.

### BACKGROUND OF THE INVENTION

It is convenient for a person to be able to carry a compact notepad for use to jot down notes such as phone numbers, dates etc. Various configurations of writing utensils which includes chambers for dispensing paper are known, the benefits being the compact nature of the package. Many such writing utensils dispense paper but do not provide facility for storage of the note.

U.S. Pat. No. 2,301,364 to Bruck et al. discloses a pencil with a booklet wound around a mandrel in the pencil casing. The paper in the booklet may be pulled through a slot in the pencil casing for use.

U.S. Pat. No. 2,512,168 to Moore discloses a pencil having a body provided with a writing point at one end. Upon the other end of the body of the pencil is mounted a hollow tube with a longitudinal slit, and into the opposite end of the tube is fitted a manually rotatable finger piece. A roll of paper is positioned within the tube with one end of the roll making its own bearing within the tube and the other end of the roll tightly fitted into a socket in the inner end of the finger piece. Rotation of the finger piece causes a strip of the paper to be torn from the roll along longitudinal score lines and fed through the slot in the tube.

U.S. Pat. No. 3,963,358 to Houser discloses a ball point pen or the like having an internal mechanism to dispense writing paper from a small roll of same confined within a cylinder cartridge within the pen housing or sheath. The cartridge has a knurled collar which is thumb-operated through an opening in the exterior sheath of the pen to rotate the cartridge approximately one-quarter turn against a spring bias to project the leading edge of the paper roll through a slot in the pen sheath. It may then be gripped and pulled by a user to a desired length and torn off.

U.S. Pat. No. 4,872,775 to Chang discloses a slip-holding pen including a slip reel, upon which is a paper roll with its two opposite ends coated and bonded by an adhesive. The slip reel is rotatably mounted in a penholder and a rotating knob clickingly rotates the slip reel to reel off the slip paper through a longitudinal slit which is formed on the penholder. Acute wedges are formed at the slit to tear the adhesive-bonded slip paper.

U.S. Pat. No. 6,135,661 to Houser discloses a writing implement having an elongated body with a chamber inside. A door with a hinge edge is movably attached to the body and, when opened, the chamber is exposed. A removable roll of paper is housable in the chamber and rollably held there. When paper is needed, the door is opened, paper unwound, the door closed and the paper torn at the door opening edge. The door opening edge has serrations to facilitate tearing.

U.S. Pat. No. 6,247,864 to Walsh discloses a paper dispensing note pen with a tubular casing and a longitudinal slot extending through the casing side. An elongate spool support member supports a spool including a plurality of sheets of paper formed into a roll about the spool. The sheets are adhered in series such that the individual sheets do not need to be torn from the roll as it is pulled through the slot.

U.S. Pat. No. 6,283,661 to Connors discloses a writing utensil that includes a generally elongated hollow housing having a first longitudinal slot, a second longitudinal slot and a third longitudinal slot. A roll of paper is rotatably mounted within the housing. The roll of paper has a leading edge that is threadable out of the housing through the first slot, back into the housing through the second slot, and out of the housing through the third slot so that a selective portion of the roll of paper is removable from the housing. Due to the multiple-slot configuration, the leading edge of the paper may be easily grasped by the user. The third slot has a tear edge for tearing a selected length of paper from the roll.

The devices disclosed in the aforementioned patents are generally similar to each other in the sense that the writing instrument and the paper dispensing mechanisms are integrated as one.

U.S. Pat. No. 6,981,813 to Thomas discloses a pen and rolled note paper system for providing note paper and a writing instrument in a single device. The system includes a roller assembly, a pen member, a paper roll, a housing and a cap. The paper roll is positionable on the roller assembly and is accessible by the user through a slot in the housing. The paper roll is moved forward to be written on and torn off, or moved backwards to manually store the written information for the user to review and use later. The pen member is slidably received in the roller assembly which in turn is positioned within the housing. The pen member may be removed from the roller assembly for use, or used while still received by the roller assembly as the user desires.

The device disclosed by Thomas suffers from the possibility of undesirable feeding forward or backwards of paper during use of the pen. This is due to the pen member when received in the roller assembly, in what would be an interference fit, rotating as it rolls over paper and in turn causing rotation of the paper roll. Furthermore, by this design, the Thomas device is limited to use of a very narrow writing instrument of a particular configuration suitable for reception by the roller assembly. People often have particular preferences as to the type and configuration of the writing utensil itself.

It is an object of an aspect of the following to provide a novel device that obviates or mitigates the disadvantages of prior art devices.

### SUMMARY OF THE INVENTION

According to one aspect there is provided an accessory for a writing utensil comprising:

a paper roll;

a housing having an outer cavity to receive the paper roll, and an inner cavity to releasably receive an end of the writing utensil;

the housing having a slot in a perimeter wall thereof to feed paper from the paper roll in the outer cavity to the exterior of the housing.

The housing having an outer cavity and an inner cavity provides the advantage that the writing utensil may be releasably received by the accessory much like a cap, but maintained isolated from the paper roll such that the writing utensil, even while it is received by the accessory, cannot be used to turn the paper roll. This configuration reduces the chances of unintentional feeding or withdrawing of the paper.

Preferably, the paper is made of mylar.

According to one embodiment, the accessory comprises a spool to support the paper roll within the outer cavity; and a knob associated with the spool and accessible external the housing for rotating the spool to thereby feed or withdraw paper on the paper roll.

The knob enables a user to feed paper out of the slot, as an additional paper-feeding option. The user may also withdraw the paper using the knob, to store a note.

According to an alternative embodiment, a spring is associated with the paper roll to bias the paper roll to a withdrawn position. Preferably, a manually releasable brake assembly is associated with the paper roll to interfere with rotation of the paper roll relative to the housing.

According to another aspect, there is provided a component of a writing utensil accessory comprising:

a housing dimensioned to releasably receive both a writing utensil and a paper roll in respective cavities thereof;

a slot in the housing dimensioned to permit feeding or withdrawing of paper between the paper roll cavity and the exterior of the body.

According to another aspect, there is provided a housing for a writing utensil accessory comprising:

a releasable writing utensil receiver; and

a paper roll receiver isolated from the writing utensil receiver;

the accessory dimensioned to permit a user to feed and withdraw paper on the paper roll.

According to another aspect, there is provided a writing system comprising:

a writing utensil;

a paper roll;

a housing having an outer cavity to receive the paper roll, and an inner cavity to releasably receive an end of the writing utensil;

the housing having a slot in a perimeter wall thereof to feed paper from the paper roll in the outer cavity to the exterior of the housing.

According to another aspect, there is provided an accessory for a writing utensil to permit a user to feed and withdraw paper on a paper roll comprising:

a releasable writing utensil receiver; and

a paper roll receiver isolated from the writing utensil receiver.

### BRIEF DESCRIPTION OF THE FIGURES

Embodiments will now be described more fully with reference to the accompanying drawings, in which:

FIG. 1 is a perspective view of a writing utensil accessory according to an embodiment of the invention;

FIG. 2 is an exploded perspective view showing the writing utensil accessory of FIG. 1 in further detail;

FIG. 3 is a cross-sectional end view of the writing utensil accessory of FIG. 1 having received the pencil;

FIG. 4 is a cross-sectional side view of the writing utensil accessory of FIG. 1;

FIG. 5 is a writing utensil accessory according to an alternative embodiment of the invention;

FIG. 6 is an exploded perspective view showing the writing utensil accessory of FIG. 5 in further detail; and

FIG. 7 is a cross-sectional side view of the writing utensil accessory of FIG. 5.

### DETAILED DESCRIPTION OF THE EMBODIMENTS

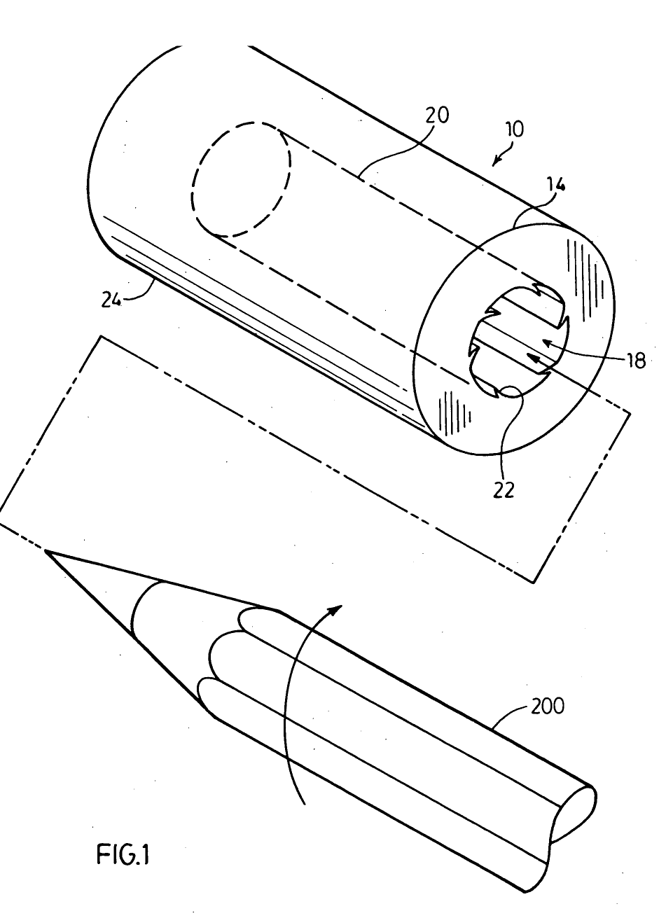

FIG. 1 is a perspective view of a writing utensil accessory 10 and a pencil 200. Accessory 10 comprises a housing 14 having an inner cavity 18 into which pencil 200 is releasably received. Inner cavity 18 is defined by an inner wall 20, protruding from which into inner cavity 18 are flexible vanes 22 for facilitating a releasable interference fit with pencil 200.

Flexible vanes 22 are provided to enable inner cavity 18 to releasably retain writing utensils of varying cross-sectional sizes and shapes. Pencil 200 may be rotated during insertion relative to housing 14 to ease reception. In a similar manner, pencil 200 may be rotated relative to housing 14 to ease release. A clip (not shown) may be affixed to housing 14 to provide facility for a user to clip writing utensil accessory 10 to clothing or another article, in a known manner.

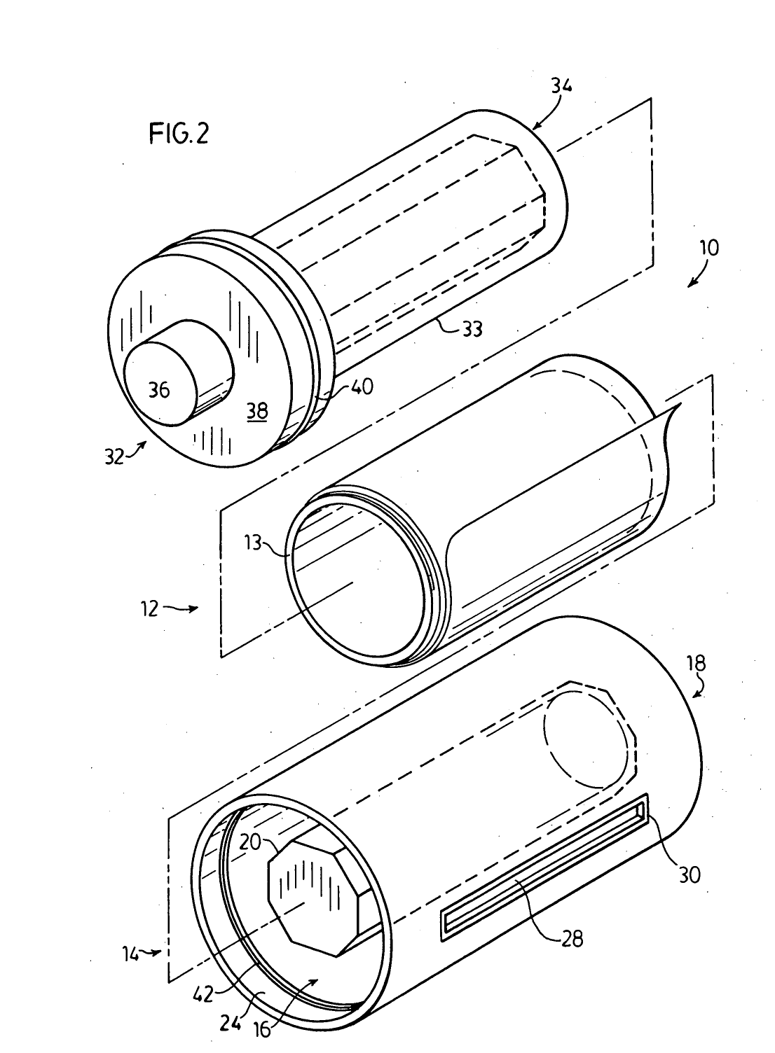

FIG. 2 is an exploded perspective view showing the writing utensil accessory 10 in further detail. A spool 32 includes an elongate generally cylindrical body 33 having a spool cavity 34 (shown in dotted lines), a cap 38 and a knob 36 protruding from cap 38. A ridge 40 protrudes from the perimeter of cap 38 for assembly of writing utensil accessory 10 as will be described.

A paper roll 12 includes a cardboard tube 13 around which is wound a strip of paper. Cardboard tube 13 has an inner diameter that corresponds generally with the outer diameter of cylindrical body 33 of spool 32, in order that cardboard tube 13 of paper roll 12 may receive cylindrical body 33 in an interference fit so that during use as will be described paper roll 12 and spool 32 may rotate in unison.

Housing 14 further includes an outer cavity 16 defined by inner wall 20 and the perimeter wall 24 of housing 14. Outer cavity 16 is dimensioned to receive paper roll 12 on spool 32 such that spool cavity 34 receives inner wall 20 as spool 32 is received in outer cavity 16. The cross-sectional size of spool cavity 34 is sufficiently larger than the cross-section of inner wall 20 to permit relative rotation of spool 32 and housing 14, as will be described.

When received by outer cavity 16 of housing 14, ridge 40 of spool 32 snaps into groove 42 of housing 14 to releasably couple housing 14 and spool 32 but to permit their relative rotation. Knob 36 is accessible external to housing 14 to permit a user to rotate spool 32.

A slot 28 is provided through perimeter wall 24 into outer cavity 16 to provide a passage through which paper from paper roll 12 may be fed out of housing 14. A grommet 30 is received by slot 28 and has rounded edges to reduce wear on paper as it is fed and withdrawn.

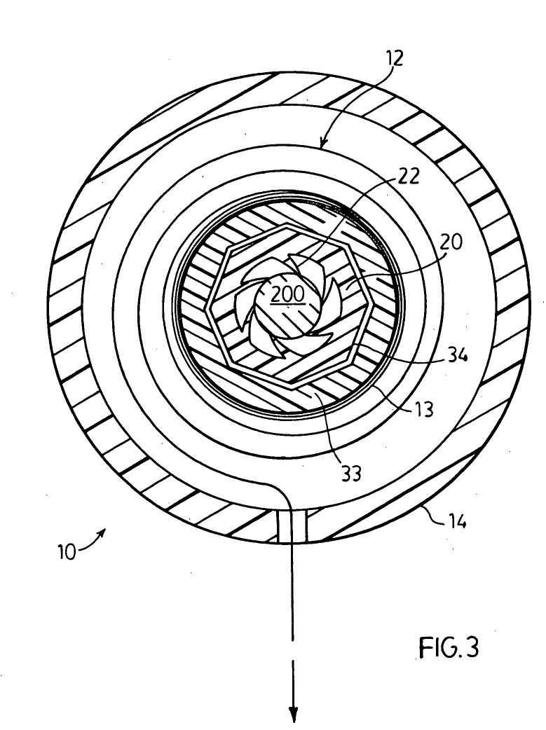

FIG. 3 is a cross-sectional end view of writing utensil accessory 10. The cross-sectional size of spool cavity 34 is larger than inner wall 20 to permit spool 32 to rotate relative to inner wall 20. However, the cross-sectional shapes of both of spool cavity 34 and inner wall 20 are octagonal to interfere with free-rotation. As such, rotation requires manual force on the part of the user such that when continually rotating upon application of manual force, a “clicking” effect is observed with only discrete quantums of paper being either fed or withdrawn with each “click”. The “clicking” effect is due to inner wall 20 and the wall of spool cavity 34 continually cycling through interference, release and clearance relative to each other. The octagonal shape provides eight (8) clicks per full rotation.

It will be noted that due to housing 14 having an outer cavity 16 and an inner cavity 18, pencil 200 is generally isolated from outer cavity 16 when received by inner cavity 18. Pencil 200 therefore does not rotate when spool 32 is rotating relative to housing 14.

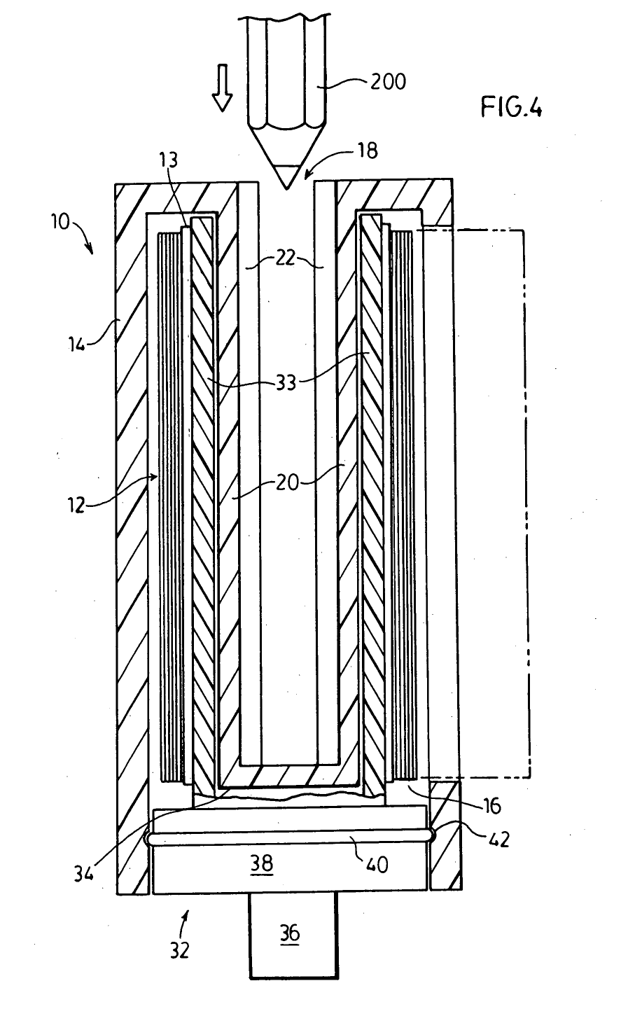

FIG. 4 is a cross-sectional side view of writing utensil accessory 10, in which the ridge 40 of spool 32 is rotatably received in groove 42 of housing 14 so as to permit relative rotation but keep the package together. In order to disassemble the parts to, for example, replace paper roll 12, a user pulls on knob 36 so as to overcome the frictional force between ridge 40 and the edge of groove 42. Once paper roll 12 is replaced on spool 32, a user pushes cap 38 so as to force ridge 40 into outer cavity 16 of housing 14 to align with and snap into groove 38.

During use, a user feeds out a quantum of paper, releases pencil 200 from inner cavity 18, and uses pencil 200 to write a note on the paper. When finished, the user re-inserts pencil 200 into inner cavity 18 and uses knob 36 to roll up the paper thereby to withdraw the paper through slot 28. Pencil 200 may be removed prior to feeding and replaced after withdrawing as desired.

Writing utensil accessory 10 may be formed of plastic, metal, ceramic or a combination of these or any other suitable materials. It will be understood that when constructed according to the embodiment described above, that some parts may need to deform relative to each other. For example, when ridge 40 of cap 38 is to be inserted into or removed from outer cavity 16, one or more of cap 38, ridge 40 and outer cavity 16 will need to temporarily slightly deform. Also, inner wall 20 and the wall of spool cavity 34 during relative rotation causing interference will be temporarily slightly deformed. As such, the materials that work together in the manners described above should be chosen such that one or the other (or both) be deformable but resilient. The particulars of material selection for writing utensils and similar accessories are well understood in the arts of manufacturing and industrial design.

Each of spool 32 and housing 14 of writing utensil accessory 10 may respectively be formed of single pieces of plastic. Alternatively, housing 14 may be formed of metal or ceramic and spool 32 of plastic. Yet another alternative is to assemble spool 32 using several pieces, such that cap 38 and knob 36 are formed of metal, ridge 40 of rubber or plastic, and cylindrical body 33 formed of plastic. This final alternative would provide a metal exterior to writing utensil accessory 10, yet provide it with resiliently deformable parts to work as described. Other materials and ways of connecting the various parts (such as by using threading for the cap in some manner rather than a rotatable snap fit) may be contemplated.

The paper on paper roll 12 is advantageously re-usable. It is therefore preferable that the paper be made of a durable material that also supports writing and erasing of pencil and/or pen markings. Once such material is mylar. Furthermore, in practice, the mylar shape memory advantageously enables it to be shaped with a wing during manufacture or even by a user such that, should its end be fully withdrawn through slot 28, it may easily be fed again through slot 28.

While octagonal cross-sectional shapes for inner wall 20 and the wall of spool cavity 34 are described, it will be understood that alternative shapes may be employed. For example, square cross-sections may be used and sizes chosen such that there are only four (4) clicks per full rotation. Fewer and greater numbers of sides of the cross-sectional polygonal shapes may be chosen. However, preferably the polygonal shapes are regular polygons to ensure that clicks are the same rotational distance apart.

An alternative to the cooperating cross-sectional shapes is to include vanes or other protrusions within spool cavity 34 or on the outside of inner wall 20 to cooperate with like vanes on the other, or with a polygonal cross-sectional shape on the other. Various configurations for achieving the interference with ergonomically appealing effect are possible.

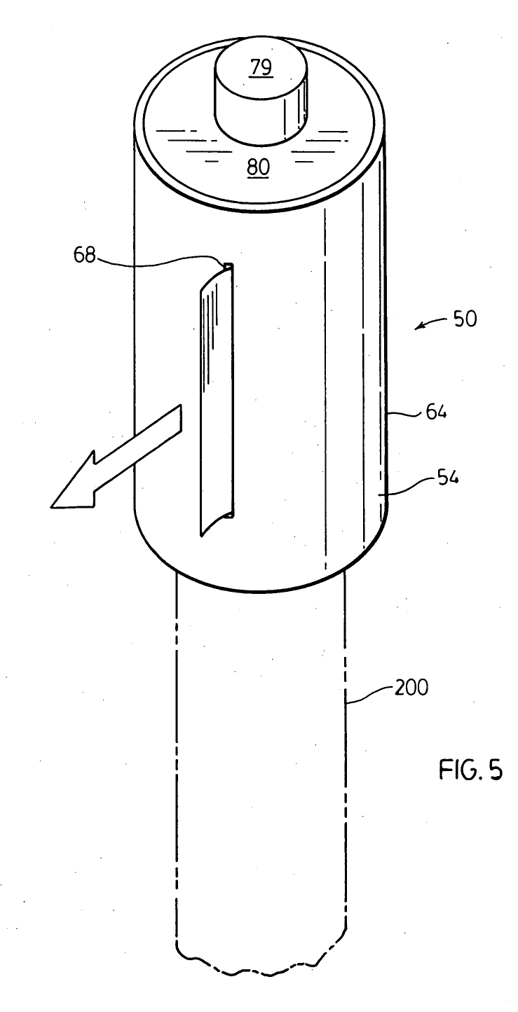

FIG. 5 is an alternative writing utensil accessory 50, shown receiving a pencil 200. According to the alternative embodiment, a paper roll 52 is biased to a withdrawn position so that a user does not have to manually roll up paper roll 52 after use.

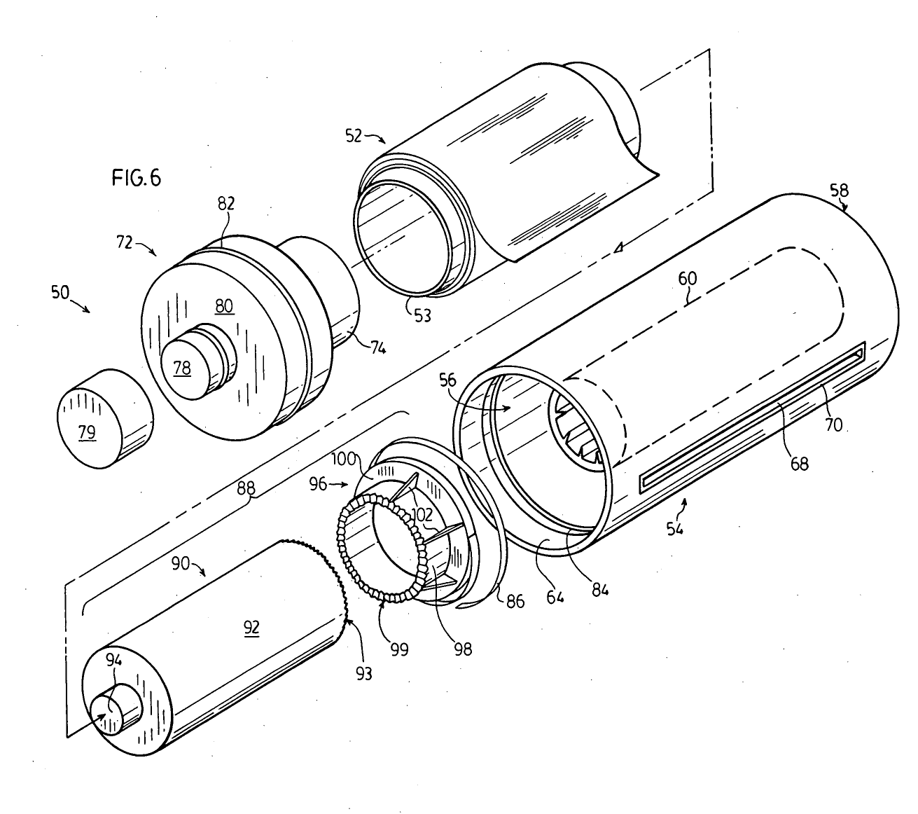

FIG. 6 is an exploded perspective view showing writing utensil accessory 50 in further detail. Accessory 50 generally comprises a spool 72, a paper roll 52, a braking assembly 88 and a housing 54.

Spool 72 includes a short generally cylindrical body 74, a cap 80 and a knob 78 protruding from cap 80. A ridge 82 protrudes from the perimeter of cap 80 for assembly of writing utensil accessory 50 as will be described.

A button 79 receives knob 78 in snap-fit so as to permit relative rotation of button 79 and knob 78 during use of accessory 50, as will be described.

Paper roll 52 includes a cardboard tube 53 around which is wound a strip of paper. Cardboard tube 53 has an inner diameter that corresponds generally with the outer diameter of cylindrical body 74 of spool 72, in order that cardboard tube 53 of paper roll 52 may receive cylindrical body 74 in an interference fit so that during use as will be described paper roll 52 and spool 72 may rotate in unison.

Housing 54 has an inner cavity 58 into which pencil 200 is releasably received. Inner cavity 58 is defined by an inner wall 60, protruding from which into inner cavity 58 are flexible vanes 62 for facilitating a releasable interference fit with pencil 200. Pencil 200 may be rotated during insertion relative to housing 54 to ease reception. In a similar manner, pencil 200 may be rotated relative to housing 54 to ease release. A clip (not shown) may be affixed to housing 54 to provide facility for a user to clip writing utensil accessory 50 to clothing or another article, in a known manner.

Housing 54 further includes an outer cavity 56 defined by inner wall 60 and the perimeter wall 64 of housing 54. Outer cavity 56 is dimensioned to receive a spiral watch spring 86 such that one end of spiral watch spring 86 is fixed to housing 54. Outer cavity 56 also receives brake assembly 88. Brake assembly 88 includes a stationary brake member 90, and a rotatable brake member 96 that may be laterally reciprocated as will be described.

Stationary brake member 90 includes a cylindrical tube 92 having an inner dimension suitable for receiving inner wall 60 of housing 54 in an interference fit. Cylindrical tube 92 of stationary brake member 90 has an outer diameter suitable for cardboard tube 53 of paper roll 52 to receive cylindrical tube 92 in non-interference fit so as to permit relative rotation of paper roll 52 and stationary brake member 90. Stationary brake member 90 also includes stationary brake member teeth 93 on an end of cylindrical tube 92 facing rotatable brake member 96. An extension 94 protrudes from an opposite end of cylindrical tube in the direction of cap 80 to be rotatably received by cap 80 as generally an axis about which cap 80 may rotate, as will be described.

Rotatable brake member 96 includes a collar 98 having an inner dimension suitable for receiving inner wall 60 while permitting rotatable brake member 96 to rotate relative to inner wall 60. Collar 98 is affixed to the end of spiral watch spring 86 that is opposite to the end affixed to housing 54. Like cylindrical tube 92 of stationary brake member 90, collar 98 may be received by cardboard tube 53 of paper roll 52. However, a flange 100 having vanes 102 protruding from collar 97 retains paper roll 52 such that paper roll 52 and rotatable brake member 96 rotate in unison. Rotatable brake member 96 also includes rotatable brake member teeth 99 on an end of collar 98 facing stationary brake member 90. Rotatable brake member teeth 99 are sized and spaced similarly to stationary brake member teeth 93 to, when selectively coupled as will be described, prevent rotation of rotatable brake member 96 relative to stationary brake member 90.

When received by outer cavity 56 of housing 54, ridge 82 of spool 72 snaps into a wide groove 84 of housing 54 to releasably couple housing 54 and spool 72 but to permit their relative rotation. Button 79 on knob 78 is accessible external to housing 54 to permit a user to feed and withdraw spool 72 as will be described.

A slot 68 is provided through perimeter wall 64 into outer cavity 56 to provide a passage through which paper from paper roll 52 may be fed out of and withdrawn into housing 54. A grommet 70 is received by slot 68 and has rounded edges to reduce wear on paper as it is fed and withdrawn.

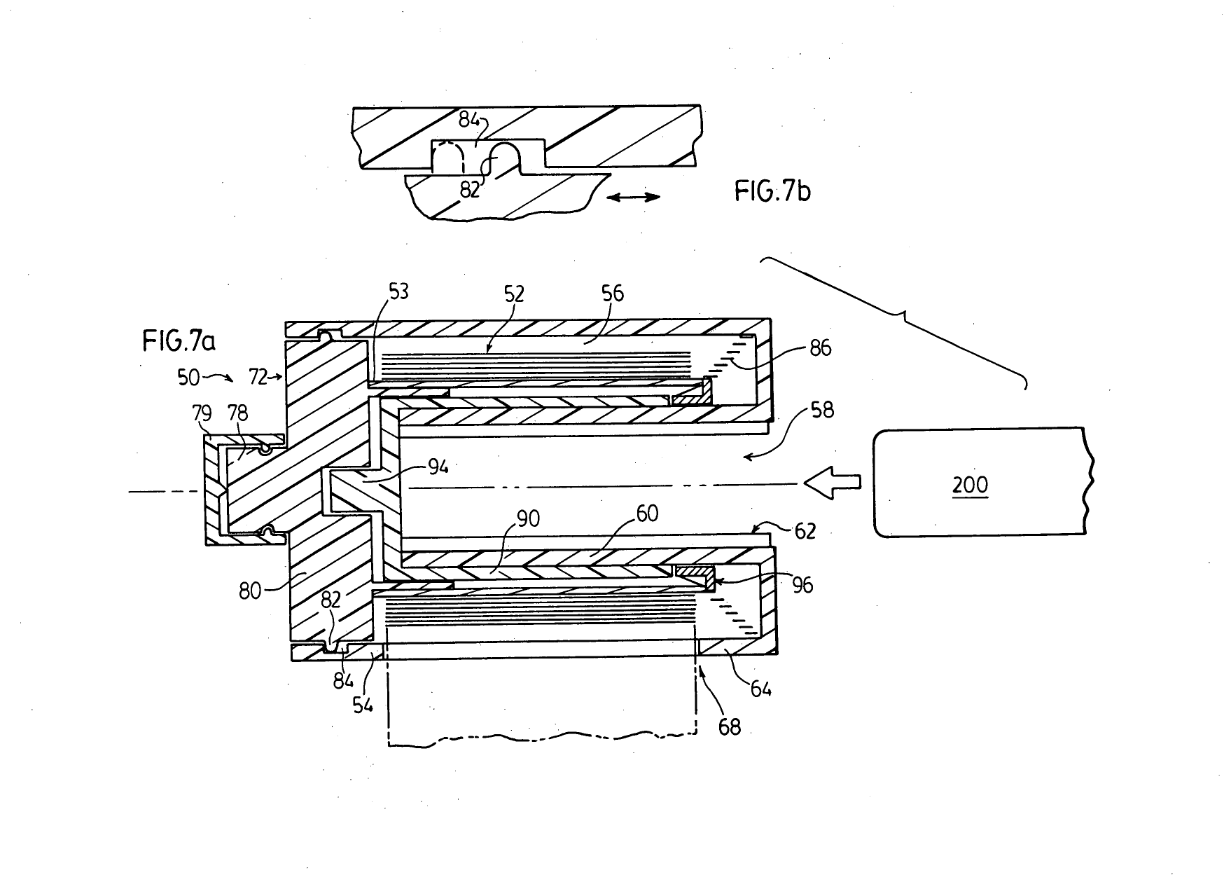

FIG. 7 is a cross-sectional side view of assembled writing utensil accessory 50. Rotatable brake member 96 and stationary brake member 90 are enmeshed due to the cooperation of the respective teeth 93, 99 under bias from spiral watch spring 86. In the position as shown in FIG. 6, spool 72 may not be rotated relative to housing 54 and therefore paper may not be pulled and therefore fed through slot 68 from outer cavity 56 through perimeter wall 64 to the exterior of housing 54.

In order to feed paper through slot 68, a user grasps the end of the paper that is accessible external the housing, and presses on button 79. Pressure on button 79 causes spool 72 to push farther into outer cavity 56 to a maximum extent governed by the extent that ridge 82 on cap 80 may be moved laterally relative to widened groove 84. Spool 72 being pushed farther into outer cavity 56 in turn causes cardboard tube 53 of paper roll 52 to push rotatable brake member 96 away from stationary brake member 90 against the lateral bias of spiral watch spring 86. When teeth 93, 99 are pushed far enough apart, rotatable brake member 96, spool 72 and paper roll 52 can be rotated in unison so as to allow the user to pull paper out of slot 68. Button 79 being rotatable relative to knob 78 permits user to maintain pressure while allowing spool 72 to freely rotate.

Release of pressure on button 79 allows rotatable spring member 96 to move under the bias of spiral watch spring 86 into a position whereby teeth 99 of rotatable brake member 96 are again enmeshed with teeth 93 of stationary brake member 90. In this position, rotatable brake member 96 having in interference fit with spool 72 prevents feeding or withdrawing of paper from paper roll 52.

Spiral watch spring 86 performs another function in addition to the biasing of rotatable brake member 96 laterally into the locking position with stationary brake member 90. The additional function is to provide a rotational bias to rotatable brake member 96. Therefore, as rotatable brake member 96 is rotated during feeding of paper from paper roll 52, spiral watch spring 86 is biasing rotatable brake member 96 rotationally to a rest position corresponding to a position in which the paper is withdrawn back through slot 68.

When it is desired to withdraw the paper into housing 54 to store a note having been written, a user simply puts pressure on button 79 to causes spool 72 to push farther into outer cavity 56 to a maximum extent governed by the extent that ridge 82 on cap 80 may be moved laterally relative to widened groove 84. Spool 72 being pushed farther into outer cavity 56 in turn causes cardboard tube 53 of paper roll 52 to push rotatable brake member 96 away from stationary brake member 90 against the lateral bias of spiral watch spring 86. When teeth 93, 99 are pushed far enough apart, rotatable brake member 96, spool 72 and paper roll 52 can be rotated in unison so as to allow the user to pull paper out of slot 68. If the paper is not being grasped by the user or otherwise held, rotatable brake member 96 under bias by spiral watch spring 86 and released from the braking position rotates to its rest position thereby rotating spool 72 and paper roll 52 to the rest position and automatically withdrawing the paper through slot 68 back onto paper roll 52.

While teeth 93, 99 of stationary brake member 90 and rotatable brake member 99 have been described as, when enmeshed, suited to prevent rotation in either direction of rotatable brake member 99 relative to stationary brake member 90, other configurations are possible. For example, a releasable pawl/ratchet configuration or alternatively-shaped teeth could be provided whereby rotation without pressure on button 79 is permitted as the user pulls on the paper. In this case rotation would cause a “clicking” effect due to the mating ratchet/pawl combination or teeth, and rotation in the opposite direction would be prevented until button 79 was pressed.

Although embodiments have been described, those of skill in the art will appreciate that variations and modifications may be made without departing from the spirit and scope of the invention defined by the appended claims.

What is claimed is:

1. An accessory for a writing utensil comprising:
a paper roll;
a housing having an outer cavity to receive the paper roll, and an inner cavity to releasably receive an end of the writing utensil;
the housing having a slot in a perimeter wall thereof to feed paper from the paper roll in the outer cavity to the exterior of the housing.

2. The accessory of claim 1, further comprising:
a spool to support the paper roll within the outer cavity; and
a knob associated with the spool and accessible external to the housing for rotating the spool to thereby feed or withdraw paper on the paper roll.

3. The accessory of claim 2, wherein the spool comprises a cap dimensioned to selectively mate with the housing for retaining the paper roll within the outer cavity.

4. The accessory of claim 3, wherein the cap includes a ridge about its outer perimeter for selectively mating with a groove in an inner perimeter of the outer cavity.

5. The accessory of claim 2, wherein the inner cavity is defined by an internal wall.

6. The accessory of claim 5, wherein the outer cavity is defined by the internal wall and the perimeter wall.

7. The accessory of claim 6, wherein the spool has a spool cavity that is dimensioned to receive and be rotatable relative to the internal wall when the spool is in the outer cavity.

8. The accessory of claim 7, wherein the spool cavity and internal wall cooperate to require application of manual force to rotate the spool relative to the internal wall, thereby to interfere with unintended feeding or withdrawing of paper.

9. The accessory of claim 8, wherein each of the spool cavity and the internal wall have polygonal cross-sectional shapes.

10. The accessory of claim 9, wherein the polygonal cross-sectional shapes are regular polygons.

11. The accessory of claim 10, wherein the regular polygons are octagons.

12. The accessory of claim 1, wherein the housing is formed of one or more of plastic, metal and ceramic.

13. The accessory of claim 2, wherein the spool is formed of one or more of plastic, metal and ceramic.

14. The accessory of claim 2, wherein the spool, the paper roll and the housing are selectively separable thereby to replace the paper roll as desired.

15. The accessory of claim 1, further comprising a grommet associated with the slot.

16. The accessory of claim 15, wherein the grommet is formed of a metal.

17. The accessory of claim 1, further comprising a clip attached to the exterior of the housing perimeter wall.

18. The accessory of claim 1, further comprising:
a spring associated with the paper roll to bias the paper roll to a withdrawn position.

19. The accessory of claim 18, further comprising:
a manually releasable brake assembly associated with the paper roll to interfere with rotation of the paper roll relative to the housing.

20. The accessory of claim 19, wherein the brake assembly comprises:
a stationary brake member associated with the housing; and
a rotatable brake member associated with the paper roll to selectively cooperate with the stationary brake member to prevent rotation of the paper roll relative to the housing.

21. The accessory of claim 20, wherein the spring biases the paper roll to a withdrawn position via the rotatable brake member.

22. The accessory of claim 21, further comprising:
a spool to support the paper roll within the outer cavity.

23. The accessory of claim 22, wherein the spool comprises a cap dimensioned to selectively mate with the housing for retaining the paper roll within the outer cavity.

24. The accessory of claim 23, wherein the cap includes a ridge about its outer perimeter for selectively mating with a groove in an inner perimeter of the outer cavity.

25. The accessory of claim 24, wherein the groove is dimensioned to permit lateral movement of the spool relative to the outer cavity.

26. The accessory of claim 21, wherein the rotatable brake member has teeth dimensioned to mesh with teeth of the stationary brake member.

27. The accessory of claim 26, wherein the spring laterally biases the rotatable brake member into contact with the stationary brake member.

28. The accessory of claim 1, further comprising flexible vanes within the inner cavity to facilitate releasably receiving the end of the writing utensil.

29. The accessory of claim 1, wherein the paper is made of mylar.

30. A component of a writing utensil accessory comprising:
a housing dimensioned to releasably receive both a writing utensil and a paper roll in respective cavities thereof;
a slot in the housing dimensioned to permit feeding or withdrawing of paper between the paper roll cavity and the exterior of the body.

31. A housing for a writing utensil accessory comprising:
a releasable writing utensil receiver; and
a paper roll receiver isolated from the writing utensil receiver;
the accessory dimensioned to permit a user to feed and withdraw paper on the paper roll.

32. A writing system comprising:
a writing utensil;
a paper roll;
a housing having an outer cavity to receive the paper roll, and an inner cavity to releasably receive an end of the writing utensil;
the housing having a slot in a perimeter wall thereof to feed paper from the paper roll in the outer cavity to the exterior of the housing.

33. The writing system of claim 32, wherein the paper is made of mylar.

34. An accessory for a writing utensil to permit a user to feed and withdraw paper on a paper roll comprising:
a releasable writing utensil receiver; and
a paper roll receiver isolated from the writing utensil receiver.

35. A writing system comprising a writing utensil and the accessory of claim 1.
